(19) United States
(12) Patent Application Publication
(10) Pub. No.: US 2011/0081243 A1
(43) Pub. Date: Apr. 7, 2011

(54) Helical airfoil wind turbines

(76) Inventor: John T. Sullivan, Marriotsville, MD (US)

(21) Appl. No.: 12/587,168

(22) Filed: Oct. 2, 2009

(51) Int. Cl. F03D 3/02; F03D 11/00

(52) U.S. Cl. 416/120; 416/176; 290/55

(57) ABSTRACT

An improved wind energy generator is described. This invention is a wind turbine that utilizes airfoils in unique designs that are made of lightweight materials. The turbine is manufactured by low cost production methods as portable units that are stacked in series to provide for significant power harvesting. The use of three dimensional twisted airfoils enable high efficiency and easy start up.

### CROSS-REFERENCE TO RELATED APPLICATION

Not Applicable

### STATEMENT REGARDING FEDERALLY SPONSORED RESEARCH OR DEVELOPMENT

Not Applicable

### BACKGROUND OF THE INVENTION

Many different types of wind turbines have been built that can efficiently convert wind energy into electrical energy. For large scale power generation, a typical configuration is a wind farm consisting of three bladed horizontal axis turbines. These turbines are very large with blades of 50-100 feet or more built upon large steel towers and are pointed into the wind. Alternatively, vertical axis wind turbines do not need to be pointed into the wind and have been built in many different designs. Many wind turbines have problems operating or starting up in low wind speed conditions, require complex mechanisms to adjust to wind conditions and can have problems with noise and vibration. Existing models are rarely suitable for congested urban conditions or portability and are not always suitable to be manufactured from low cost materials.

This invention is of a lightweight wind turbine that can be mounted either vertically or horizontally and is lightweight and portable. This wind generator utilizes an airfoil on the leading edge that is twisted into a three dimensional shape and consists of stackable units. Each unit can be inexpensively manufactured from lightweight materials, for example injection molded plastic or inflatable rubber. The units then connect together in a stack with the assembly held together by a central pole or cable. This design solves the problem of portability but retains the ability to provide for significant power generation when multiple units are stacked in series. One embodiment is of an efficient wind turbine that utilizes uniquely shaped three dimensional airfoil blades with opposing pitches of a helix twist angles to create beneficial wind flow during both low and high wind speed conditions. Other embodiments of this invention include methods of operation including multiple mounting configurations and the use of the turbine to generate power underwater.

Several typical examples of turbines for wind power will be described, however none have the same characteristics as those of this invention. These examples represent the state of the art or the closest examples to this invention. In U.S. Pat. No. 7,362,004 B2, Becker describes a wind turbine made of straight outer airfoil blades and inner helical wing blades supported within a cage structure. As with many other wind turbines, a protective cage structure is required that adds expense, complexity and significant weight. In another example of a wind generator, Stephens describes a wind driven generator including a rotor comprised of blades in a cylindrical duct in U.S. Pat. No. 7,365,448 B2. This design is compact and much like a paddle wheel enclosed within a cylindrical housing. It also uses cams to put the blades into the wind.

There are several commercial examples of portable wind generators. The Magenn Power Air Rotor System is a cylindrical turbine structure that is floated from 200-1,000 feet above ground transmitting energy through a tether. It is a lighter than air system that could be portable, but it is a complex design that is inherently costly to produce. The Quietrevolution QR5 has a helical design with three helical blades. Carbon fiber is used to manufacture the blades, which is a commonly used material for turbine blades. However, carbon fiber blades are costly and typically manufactured in small lots by hand. One example of a turbine that utilizes low cost plastic is Oregon Wind Corp.'s Urban Turbine™. This design uses a helical blade on a central pole that is encaged in a steel or aluminum bracket.

One type of wind turbine that has some similar features is the giromill or cycloturbine variety of vertical axis wind turbine. These are typically powered by three vertical airfoils attached by radial arms to a central rotating mast and were first described in U.S. Pat. No. 1,835,018 By Darrieus. Since radial airfoils are most effective at higher wind speeds, the cycloturbine variation alters the pitch of the airfoils to create drag for starting and then to generate greater lift to accelerate rotation. In a further evolution, Darrieus type vertical turbines have been built with helically twisted airfoil blades. The Quietrevolution and Turby brand commercial products have three vertical blades, each with a 60 degree helical twist. Start up for these models is typically achieved by using the generator as a motor. In U.S. Pat. No. 6,253,700 Gorlov teaches a helical turbine assembly that has primarily been used as a hydrofoil, producing energy from flowing water and works under the same principles as the Darrieus wind turbines. Savonius type wind turbines use scoops to create drag to turn a central shaft. Combinations of Darrieus and Savonius type units have been built with radial airfoils and cups attached to the central shaft to facilitate starting have been developed such as that in U.S. Pat. No. 3,918,839. In this design, starter rotors are used to only harness drag and facilitate rotation of the main shaft such that the exterior airfoil blades can then efficiently capture the wind energy.

### BRIEF SUMMARY OF THE INVENTION

It is an object of this invention to provide for an improved wind energy generator. This invention is a wind turbine that utilizes airfoils in a unique design that are made of lightweight materials. Further, the turbine is manufactured as relatively small units by low cost production methods, and these portable units could be stacked in series to provide for significant power harvesting. It is a further object of this invention to provide a wind turbine made from a three dimensional twisted airfoil. The airfoil can contain two, three or four blades.

It is a further object of this invention to provide a wind turbine comprised of airfoil blades made from a flexible material such that the blades bend towards the center of the turbine upon their return into the wind. This effectively reduces negative drag to further increase efficiency.

It is a further object of this invention to provide for airfoils in which the twisted blades contain cut-outs, or hollow sections in blades. These hollow sections provide for a decreased weight of the turbine while not reducing its efficiency.

It is a further object of this invention to provide a wind turbine that could be assembled from portable unit pieces to the desired length. It is a further object of this invention to provide a wind turbine that is lightweight and portable and requires minimum external support.

It is a further object of this invention to provide a wind turbine constructed from inflatable airfoils. It is a further object of this invention to provide a wind turbine that could be easily mounted on a roof, a pole, or a horizontal cable. It is a further object of this invention to provide a wind turbine that is portable and could be transported and then mounted on a vehicle, or on a cable between two vehicles. It is a further objective of this invention to provide an inflatable wind generator with a swivel joint. This allows the inflatable design of the airfoil to be mounted between trucks, buildings, or other structures. It is a further object of this invention to provide for an airfoil generator system in which multiple airfoil units are mounted horizontally on wheel hubs. It is a further object of this invention to provide a turbine unit that can be used underwater to generate hydro power. The hollow plastic airfoil units of this invention could be filled with foam or another substance to increase rigidity for underwater use.

It is a further object of this invention to provide for a double airfoil turbine that has an interior twisted airfoil and an outer airfoil.

It is a further object of this invention to provide for airfoil wind turbines that provide better efficiency by utilizing airfoil segments with opposing pitches.

It is a further object of this invention to provide an air turbine that is comprised of a central airfoil that is highly efficient at low wind speeds, and a plurality of circumferential airfoils to provide greater efficiency at higher wind speeds. Preferably, the assembly consists of three circumferential airfoils, although there can be fewer or greater than three. The spin of the air turbine rotates a central shaft that powers a generator. It is a further object of this invention to provide for an air turbine with a central airfoil and a plurality of circumferential airfoils in which said central airfoil is of a multiple bladed inverted helix. Preferably, said central airfoil consists of three blades although there can be fewer or greater than three blades. More preferably, the central airfoil is comprised of two joined parts; one half with a clockwise helix and one half with a counterclockwise helix.

It is a further object of this invention to attach, via a spoked hub, a plurality of circumferential airfoils to the central twisted helix airfoil. The circumferential airfoils are single blades and can either be a flat or bent, or be comprised of two conjoined twisted segments of opposite pitch. In each case, said spoked hub must have arms long enough so that the central airfoil can spin without interference from the circumferential airfoils.

It is a further object of this invention to provide for an improved energy generator in which a plurality of airfoils are positioned circumferentially around a central rotating shaft to power a generator. In this design, the circumferential airfoils taught previously are attached to each other via spoked hubs and no central airfoil is necessary. In a preferred embodiment, the circumferential airfoils are of a single bladed helical configuration. Further preferred is that multiple assemblies of these airfoils, connected by spoked hubs, be stacked with the pitch of the adjoining airfoil blades alternating between clockwise and counterclockwise. There can be any number of these blades. In another embodiment, some of the spoked hubs are removed and instead the circumferential pitched airfoil blades are connected to each other by means of integral tabs. For these configurations, the V-shaped counterclockwise and clockwise helix airfoil turbine can be asymmetrical or symmetrical or a combination of both in a helix profile.

It is a further object of this invention to provide for an improved energy generator in which a plurality of circumferential airfoils are attached via a hub to a central rotating shaft. In this embodiment, the helical airfoils are wing tipped and the tipped ends are not attached to a hub. This type of configuration prevents roll off at the end of the airfoil for better efficiency.

It is a further object of this invention to provide for a collapsible energy generator in which a plurality of hinged airfoil blades are mounted circumferentially to spoked hub on a rotating shaft. The blades are preferably of opposing pitches with a hinge in the middle and at the spoke connection.

### BRIEF DESCRIPTION OF THE DRAWINGS

To improve the understanding of this invention, figures are provided to better describe examples of design and operation. These drawings represent examples of preferred embodiments but additional designs and operational conditions may also be included in this invention. While each example is described as a wind powered device comprised of airfoils, it is also possible to be utilized as a water powered device comprised of hydrofoils.

FIG. 1 shows multiple airfoil units stacked together and mounted on a central pole.

FIG. 2 shows two individual units of a twisted airfoil design with end caps.

FIG. 3 shows the end view of a three vane airfoil.

FIG. 4 is a flexible three vane airfoil.

FIG. 5 is a four vane airfoil built from a stack of individual units.

FIG. 6 shows a stack of airfoils with a hollow cutaway manufactured in the side of each blade.

FIG. 7 shows the details of how a clockwise pitched airfoil is stacked upon a counter-clockwise pitched airfoil.

FIG. 8 details a counter-clockwise pitched airfoil stacked upon a clockwise pitched airfoil.

FIG. 9 shows multiple inflatable airfoil units tethered to a ground unit spool.

FIG. 10 shows multiple airfoils mounted on a hub.

FIG. 11 is an airfoil assembly with an attached swivel joint.

FIG. 12 is an assembly with a twisted inner airfoil and outer airfoil.

FIG. 13 is a wind turbine with an inverted clockwise and counterclockwise helical three bladed central airfoil and three circumferential bent airfoils.

FIG. 14 is a wind turbine with an inverted clockwise and counterclockwise helical three bladed central airfoil and three circumferential inverted clockwise and counterclockwise helical airfoils.

FIG. 15 is a wind turbine with three inverted clockwise and counterclockwise helical airfoils.

FIG. 16 shows a stack of multiple airfoil wind turbines.

FIG. 17 illustrates a collapsible airfoil assembly in which each of the airfoil blades is hinged.

### DETAILED DESCRIPTION OF THE INVENTION

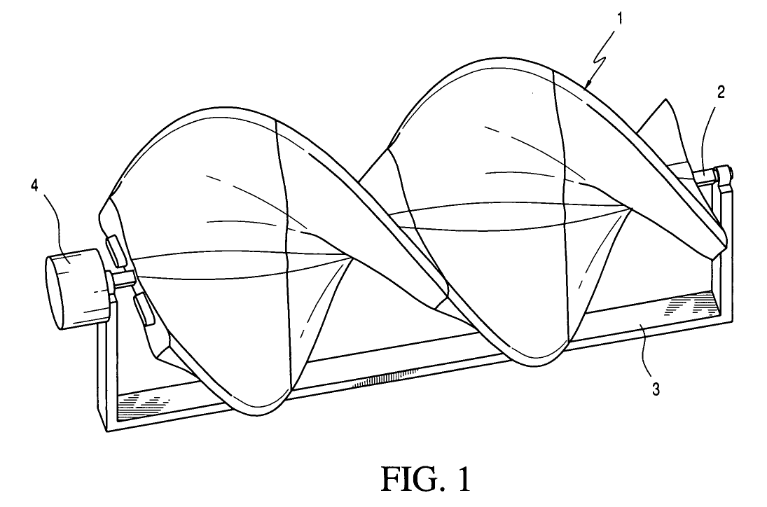

An assembly, built of multiple individual airfoil units 1 is shown in FIG. 1. This assembly is mounted on a center pole 2 that is attached to a frame 3 to which a generator 4 is attached. This design is a true airfoil design and thus it is always exposed to the wind regardless of wind direction. The airfoil of this invention provide a leading edge like an airplane wing and thus provides separation of the airflow between the top and bottom sections of the airfoil in such a manner that it generates lift in addition to being pushed. The combination of lift and push is not typical for conventional wind turbines and provides for improved efficiency.

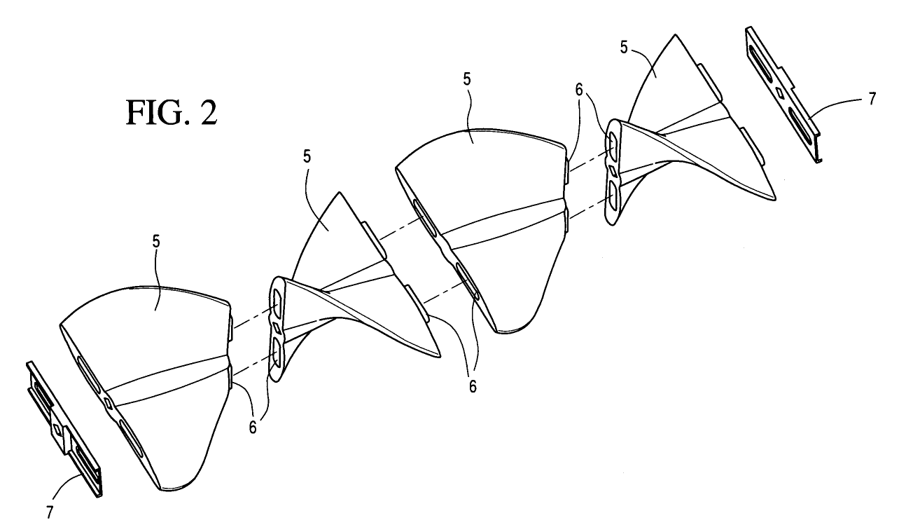

The twisted airfoil, shown in FIG. 2, is comprised of multiple units that stack upon each other until the desired size is formed. Shown are the individual unit 5, and the manner in which these units attach to each other 6. Also shown are optional metal end caps 7 that fit into the bosses on both ends and provide a strong attachment point. Typically, wind turbines require a large size to produce significant power but large blades or turbine components made of the requisite lightweight materials require expensive hand made manufacturing whereas the stackable units of this invention could be manufactured by low cost processes including plastic injection molding. The design of the individual units is unique in that it includes both mechanical interconnects on the ends of each unit and a hollow square central section, in which a pole or cable runs, that acts as a keyway. For larger units, metal end caps could be inserted between sections to provide additional strength. Having individual units lowers manufacturing costs as well as transportation costs over having a one piece large turbine.

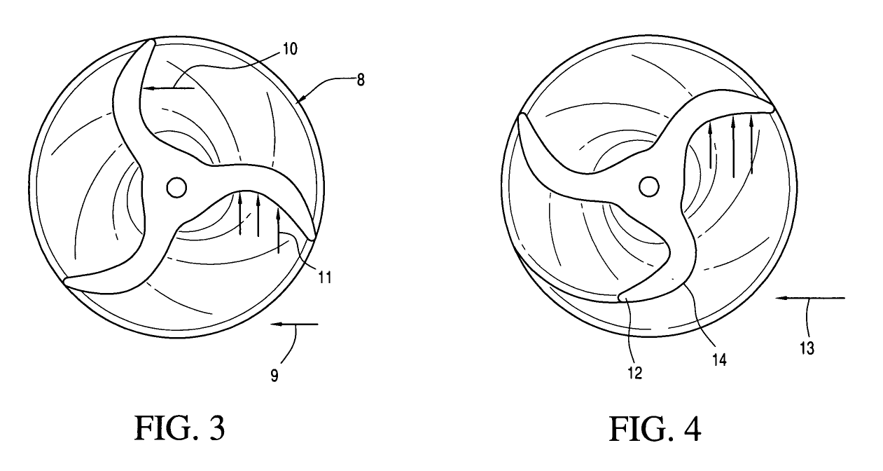

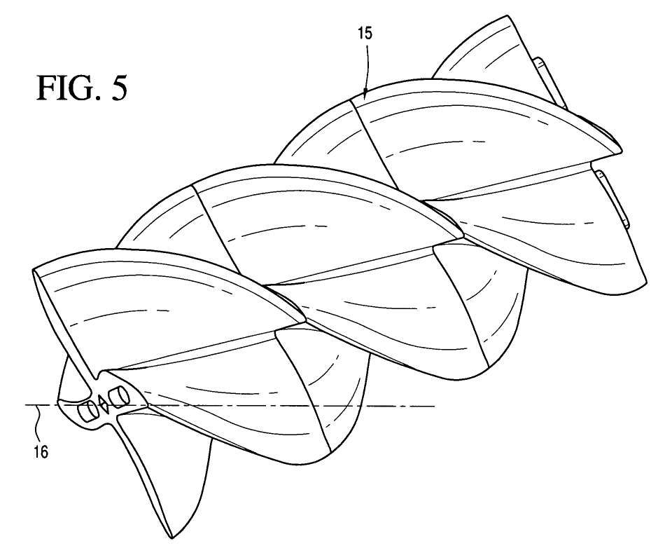

FIG. 3 is an end view of a three blade twisted airfoil unit 8. The airfoil blades are designed such that the wind 9 provides both push 10 and lift 11. FIG. 4 shows this airfoil unit constructed of a flexible material such that the blade tips 12 are pushed towards the center thus reducing the negative drag as the wind 13 contacts the uncapped side of the airfoil 14.

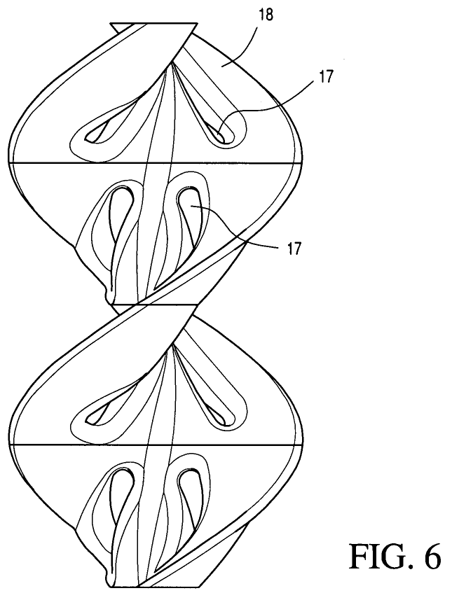

FIG. 5 shows a four-bladed airfoil 15 with the blades tilted at the optimum 33-degree angle from normal 16. While this angle is believed to be the optimum for efficiency, it is understood that different angles of the airfoil into the wind will also be effective.

FIG. 6 is a stack of twisted airfoil units in which a portion of the center of each blade is removed 17 to reduce the weight of the structure. Since the leading edge 18 is a true airfoil, the wind is deflected both over and under the blade and thus the center part of the blade is not needed to obtain the desired turbine effect. Note that this concept of hollowing the blade center could be done in other shapes and could be used on three- and four-bladed airfoils as well.

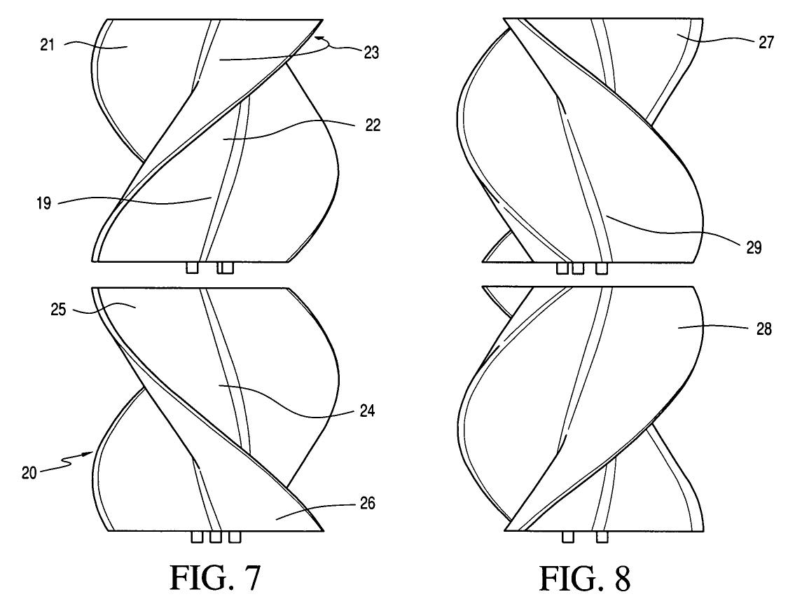

FIG. 7 shows a configuration of how two airfoil units could be stacked together. A three blade airfoil unit with a clockwise spiral 19 is attached to a three blade airfoil unit with a counter-clockwise spiral 20. In this configuration, the leading edge 21 directs the wind into the center of the turbine 22 and sets up the direction of spin with the curve of the airfoils 23. The mid section of the airfoil 24 acts like a wing while the leading edge 25 is an airfoil can create both push and lift creating this spin. The section 26 is bent over to reduce drag as it rotates forward into the funnel zone.

FIG. 8 shows a configuration in which a three blade counter-clockwise spiral airfoil 27 is attached to a three blade clockwise-spiral airfoil 28. In this configuration the air stream converges towards the center foil 29 such that the force is concentrated increasing the efficiency of the system. The spirals also tend to direct the air outward in the opposite direction on the back side of the turbine.

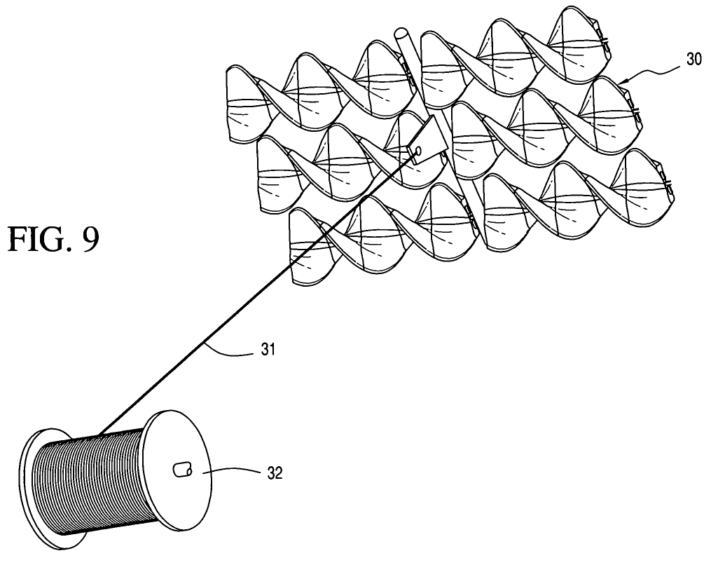

Although the helical turbines described herein could be mounted horizontally or vertically FIG. 9 shows another operation mode in which lighter than air inflatable gangs of airfoils 30 are tethered by a cable 31 to a spool 32 that is mounted on a vehicle or on the ground. The inflatable airfoil is made of a rubber-like material and can be mounted inside a fabric cover to which cables could be attached. The hollow airfoil could be filled with lighter than air gas and floated on a cable tether into the atmosphere where the wind currents are strong.

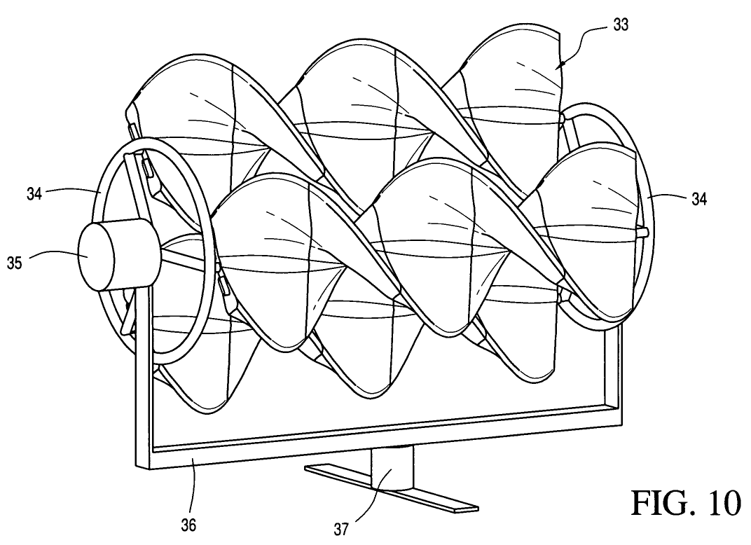

Another operation mode is shown in FIG. 10 where gangs of airfoils 33 are mounted to common hubs 34 such that the cumulative mechanical energy is captured by the hub mounted generator 35. The hubs are attached to a bracket 36 that is mounted on a swivel 37 that can rotate the entire assembly into the wind. There can be different variations of this configuration including designs in which each twisted airfoil assembly powers an individual generator.

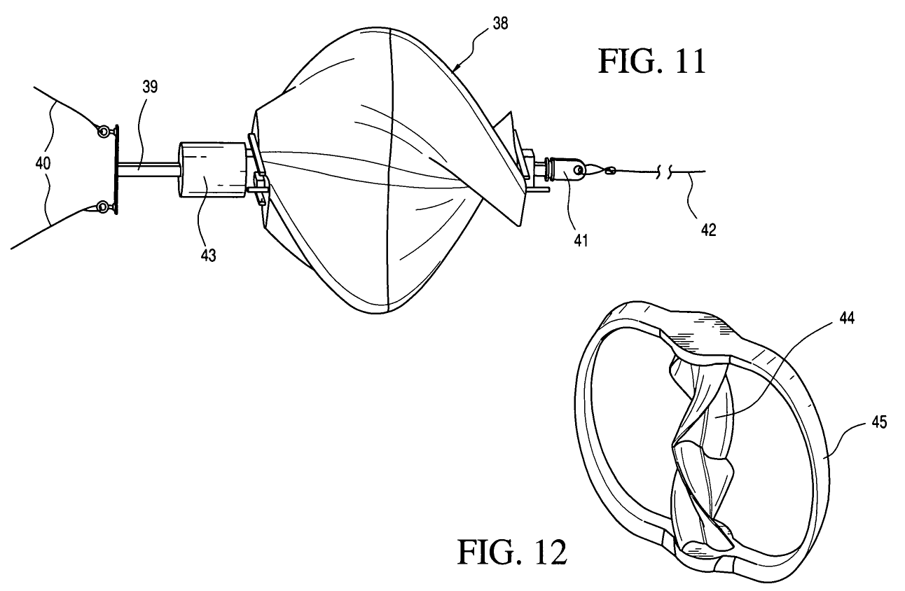

Another operation mode is shown in FIG. 11 where the turbine 38 is mounted horizontally on a pole 39 that is attached to a plurality of cables on one side 40 and to a swivel joint 41 connected to a cable 42 on the other. The swivel joint prevents tangling of the cable, while the generator 43 captures the mechanical energy from the spinning pole. The twisted airfoil of this invention simply needs a pole or cable running through the center to support it, perhaps with metal end caps between individual sections. Most other turbines require a large heavy aluminum or steel cage structure with welded bracket hubs to hold it together. This increases the weight of this other system significantly. In addition to stationary structures, it is an objective of this invention to provide a wind turbine that can be easily mounted to mobile structures, such as trucks and boats.

FIG. 12 shows yet another operational mode in which the built up twisted airfoil turbine 44 is combined with an outer airfoil 45. This configuration improves efficiency in that the inside foil spins better at low wind speeds while the outer foil can better utilize higher wind speeds.

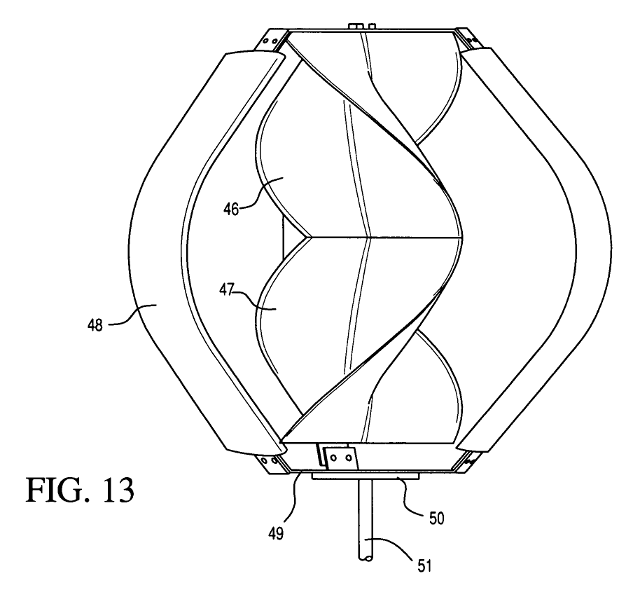

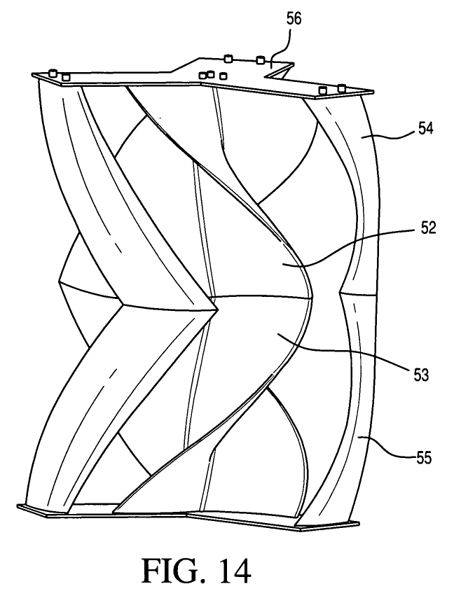

FIG. 13 shows an example of a wind turbine comprised of a three dimensional inverted clockwise and counterclockwise central helical airfoil with three circumferential airfoils. The central airfoil is comprised of two separate three bladed winged airfoils, one winged helical airfoil in the counterclockwise direction 46 and the other winged helical airfoil in the clockwise direction 47, that are joined together. They can also be molded as one continuous part. When a clockwise rotated airfoil is attached to a counter-clockwise rotated airfoil, the spinning action of this system in the wind will create a vacuum where the two halves meet. This effective pushing of the air into the center, while pushing it away from the center on the backside is not found in standard turbines. The wind turbine of this example also is comprised of three Darrieus type circumferential airfoils 48 that are bent outward to allow for the central airfoil to spin freely. The central airfoil is attached to a three spoke hub 49 on the top and the bottom; the spokes of which are attached to the three circumferential airfoils. The central airfoil is very efficient in low wind speed conditions and the three circumferential airfoils are very efficient at high wind speeds. Also visible is the mounting hub 50 and the central rotating shaft 51 that the turbine is attached to and powers the generator. Note that the circumferential airfoils are optional and can be omitted or can be configured differently, such as straight blades, with corresponding changes in the spokes. Although the central and circumferential airfoils may spin independently of each other, it is preferred that they are fixed in position relative to each other such that they spin together. In this way the central airfoil can effectively be used to start up the assembly in low wind conditions and the circumferential airfoils can impart greater efficiency once the turbine is spinning. While any number of circumferential airfoils can be utilized, three are used in the preferred embodiment.

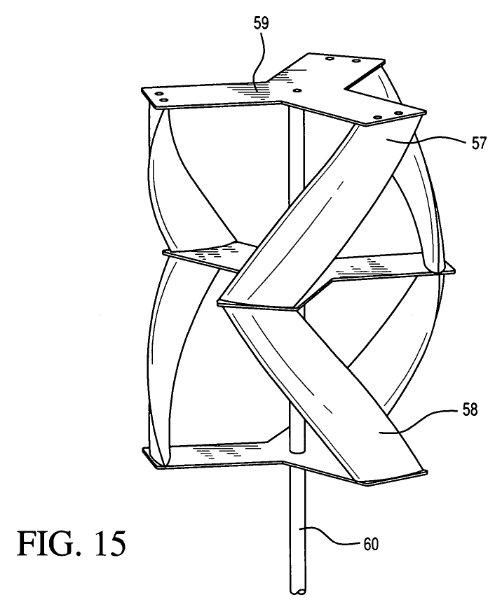

The central three bladed airfoil in the example shown in FIG. 14 is the same as the central airfoil used in the previous figures with a counterclockwise helix half 52 joined to a clockwise helix half 53. In this example the three circumferential airfoils are also comprised of a counterclockwise helix half 54 joined to a clockwise helix half 55. The central and circumferential airfoils are all connected to a three spoke central hub 56 on each end. The leading edge of the two counterclockwise and clockwise airfoils direct the air outward while the back side of these two helices directs the fluid inwards. A vacuum is created by the air moving outward, and the air is rapidly pulled into the center leading to a very high efficiency. This wing shaped turbine airfoil design can self start in low wind conditions and work efficiently in high winds without the need for an interior drag foil. The improved three dimensional helical wing shape effectively produces drag in low winds and lift in high winds across the leading edge airfoil shape not found on conventional helix designs. This contrasts with the single Darrieus helix designs that have difficulty starting in low winds.

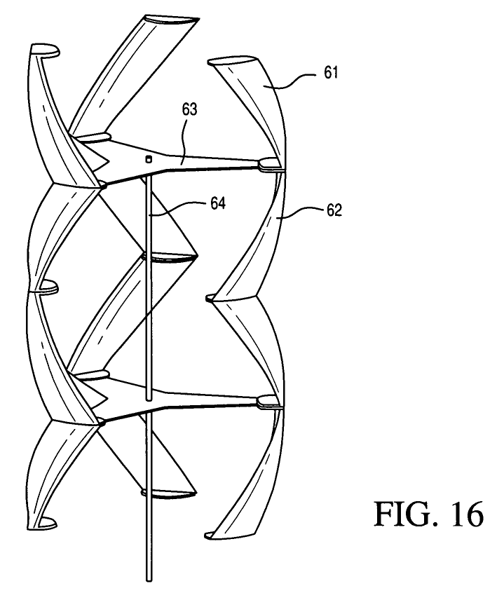

FIG. 15 represents a similar wind turbine as the previous examples, except that the central airfoil is absent. Instead there are three circumferential airfoils, each with half of the airfoil helix clockwise 57 and half helix counterclockwise 58 joined by a three spoke hub 59 at the top, middle and bottom. Through the center of the assembly a rotating shaft 60 is attached to each of the three spoked hubs.

FIG. 16 is an example of a similar multiple helix airfoil wind turbine to FIG. 15 in which two units are stacked to provide for a larger more powerful unit. However in this example, the ends of each helical airfoil have a tab such that they could be connected directly to the next twisted airfoil. As shown, the central three spoked hub of FIG. 15 is no longer necessary in this configuration. Visible is the circumferential airfoil blade segment with a clockwise helix 61 and a segment with a counterclockwise helix 62. The circumferential airfoils are connected by three spoke hubs 63 and a central rotating shaft 64 powers the generator.

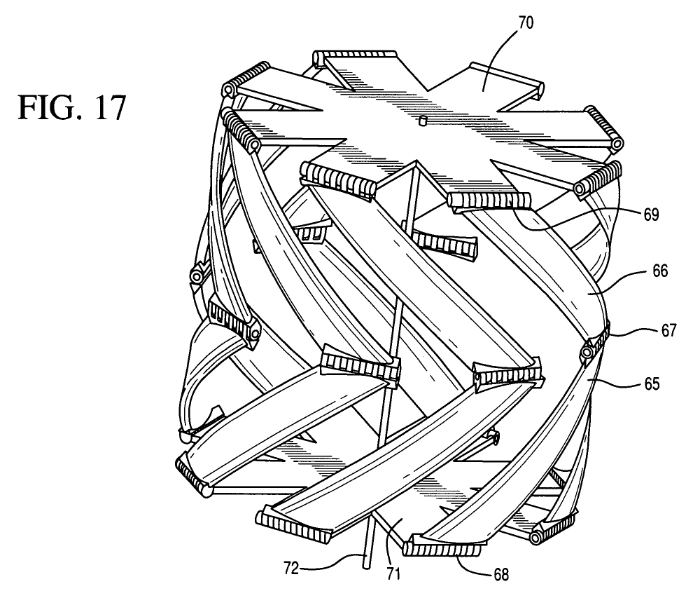

An example of the type of wind generator described by this invention in a collapsible configuration is shown in FIG. 17. In this model, the counterclockwise helical half of the airfoil 65 is connected to the clockwise helical half 66 by a hinge 67. Hinges 68 and 69 connect the airfoils to spoked hubs 70 and 71 that are attached to the central rotating shaft 72. This entire assembly can collapse for a very portable energy generator. This configuration still provides for the improved efficiency of the opposed pitched blade combination, yet in a portable design.

1. A wind turbine comprising:
a plurality of blades that radially extend from a longitudinal axis;
each of said blades are airfoils with their leading edges extended outwards from said longitudinal axis;
each of said blades are twisted in a helix shape about said longitudinal axis;
said longitudinal axis is coincident with a rotatable shaft that is mounted to an electrical generator.

2. The wind turbine of claim 1 wherein the number of said blades is either 2, 3 or 4.

3. The wind turbine of claim 1 wherein said helical twist of the airfoil blades is at a 33 degree angle from said longitudinal axis.

4. The wind turbine of claim 1 wherein the direction of said helical twist alternates from clockwise to counterclockwise along the length of said longitudinal axis at least one time resulting in adjacent segments with opposed pitch helices.

5. The wind turbine of claim 1 wherein said blades are structurally flexible such that upon rotation, the leading edge tips of said blades bend towards said longitudinal axis upon their return into the wind.

6. The wind turbine of claim 1 wherein a portion of the face of each of said blades is removed to decrease the weight of the structure.

7. The wind turbine of claim 1 wherein said blades are manufactured from a flexible material such that it is inflatable.

8. The wind turbine of claim 1 wherein said wind turbine is portable and mountable on a pole, cable or swivel joint at said longitudinal axis.

9. The wind turbine of claim 1 wherein said turbine is used underwater for hydro power generation.

10. The wind turbine of claim 1 that is further comprised of a plurality of airfoil blades that are attached to the ends of said helical blade assembly or to hubs attached to the ends of said helical blade assembly and extend beyond the outer diameter of said helical blade assembly and rotate concentrically about said longitudinal axis.

11. The wind turbine of claim 10 wherein said attached airfoil blades are twisted in a helical shape.

12. The wind turbine of claim 11 wherein the direction of said helical twist of the attached airfoil blades alternates from clockwise to counterclockwise along the length of each blade at least one time resulting in adjacent segments with opposed pitch helices.

13. A wind turbine that is comprised of a plurality of individual longitudinal segments of radially extended airfoil shaped blades such that the assembly of said segments provides for an effective wind energy power generation device.

14. The wind turbine of claim 13 wherein said longitudinal turbine segments are manufactured from a lightweight material and are hollow.

15. The wind turbine of claim 13 wherein said longitudinal turbine segments contain a central keyway to accommodate a cable or shaft through the assembled wind turbine.

16. The wind turbine of claim 13 wherein caps are fitted to the free ends of said assembled wind turbine to provide for increased strength and stiffness.

17. The wind turbine of claim 13 wherein said airfoil shaped blades are twisted in a helix shape about their longitudinal axis and assembled such that the position and twist of each of said blades in adjacent segments is aligned.

18. The wind turbine of claim 17 wherein said longitudinal turbine segments are assembled such that the pitch of adjacent segments alternates between clockwise and counterclockwise.

19. A wind turbine comprising:
a rotatable shaft mounted to an electrical generator;
a plurality of evenly spaced circular spoked hubs through which said rotatable shaft is attached to the center point of each hub;
a plurality airfoil blades that are attached to the outer edge of the spokes that comprise said hubs, such that the blade between each hub is a discrete segment and each such blade connects adjacent hubs;
each said discrete airfoil blade segment is twisted in a helix orientation about said central axis that is also defined by the rotatable shaft.

20. The wind turbine of claim 19 wherein said discrete airfoil blade segments are assembled such that the pitch of the helix orientation of adjacent blade segments alternates between clockwise and counterclockwise.

21. The wind turbine of claim 19 wherein said attachment between said spoked hubs and said airfoil blade segments is facilitated via a hinge mechanism.

22. The wind turbine of claim 21 that is further characterized by having all but one of said plurality of hubs capable of sliding in relation to said rotatable shaft, the remaining one fixed to the shaft, such that the spoke and airfoil blade assembly is collapsible.

23. The wind turbine of claim 21 that is further characterized by having two circular spoked hubs, one fixed and one capable of sliding in relation to said rotatable shaft, and also further characterized by having twice the number of airfoil blade segments than the number of spokes of each hub; and the wind turbine is assembled such that the first end of an airfoil blade segment is attached by hinge to a spoke of the first hub, and the second end of said airfoil blade segment is attached by hinge to the first end of another airfoil blade segment, the second end of which is in turn attached by hinge to a spoke of the second hub in an arrangement that effectively eliminates a central spoked hub where the adjacent airfoil blade segments meet and thus the entire assembly is collapsible upon itself due to the hinged construction.
